(19) United States
(12) Patent Application Publication
(10) Pub. No.: US 2019/0122274 A1
(43) Pub. Date: Apr. 25, 2019

(54) Scanning Apparatus and Corresponding Method

(71) Applicants: Rachelle Samson Lucarelli, Ocean, NJ (US); Bruno Lucarelli, III, Ocean, NJ (US)

(72) Inventors: Rachelle Samson Lucarelli, Ocean, NJ (US); Bruno Lucarelli, III, Ocean, NJ (US)

(21) Appl. No.: 16/200,091

(22) Filed: Nov. 26, 2018

Related U.S. Application Data
(63) Continuation-in-part of application No. 16/002,605, filed on Jun. 7, 2018.
(60) Provisional application No. 62/517,039, filed on Jun. 8, 2017.

(51) Int. Cl. G06Q 30/06; G06K 9/22; G06Q 30/02

(52) U.S. Cl. CPC G06Q 30/0611; G06Q 30/0278; G06K 9/228

(57) ABSTRACT

These embodiments support and facilitate providing one kind of categorical type of information regarding an item to a particular person who is presumptively seeking a different kind of categorical type of information regarding that item. By one approach these teachings provide a portable handheld device having an optical scanner and a wireless communications capability. That portable handheld device serves to scan an optical identification code on the aforementioned item and to transmit identification information corresponding to that optical identification code to a particular remote resource. Upon receiving the aforementioned one kind of categorical type of information from the remote resource at the portable handheld device, at least some of that information can be printed as hard copy and provided to the aforementioned person.

### RELATED APPLICATION(S)

This application is a continuation-in-part application of co-pending and co-owned U.S. patent application Ser. No. 16/002,605 filed Jun. 7, 2018, which claims the benefit of U.S. Provisional application No. 62/517039 filed Jun. 8, 2017, both of which are incorporated by reference in their entirety herein.

### TECHNICAL FIELD

These teachings relate generally to scanning and scanning-based information retrieval.

### BACKGROUND

Modern technology facilitates accessing a wide variety of information. Various information sources and databases can be accessed, for example, via home computers and laptops as well as mobile platforms such as pads/tablets and so-called smart phones.

Generally speaking, however, a particular individual person usually gains access to such content by way of user-initiated searches and/or queries. That is, a person who can gain something by accessing certain information must typically themselves initiate the inquiry in order to obtain that information. For example, a person who might benefit from knowing the appropriate first aid protocol for a particular injury must usually formulate and initiate a query in those regards. As another example, a person who might benefit from knowing a current market value for their used automobile must again usually formulate and initiate a corresponding query.

The applicant has determined that current practices in the foregoing regards do not necessarily meet all needs in all application settings. In particular, and as an example, a person who does not recognize the potential value of having and knowing certain information in a certain application setting will be unlikely to take any steps to acquire that information and hence will be denied any benefits that correspond to having that information.

### BRIEF DESCRIPTION OF THE DRAWINGS

The above needs are at least partially met through provision of the scanning apparatus and method described in the following detailed description, particularly when studied in conjunction with the drawings, wherein:

FIG. 1 comprises a flow diagram as configured in accordance with various embodiments of these teachings;

FIG. 2 comprises a block diagram as configured in accordance with various embodiments of these teachings;

FIG. 3 comprises a block diagram as configured in accordance with various embodiments of these teachings;

FIG. 4 comprises a screen shot as configured in accordance with various embodiments of these teachings;

FIG. 5 comprises a screen shot as configured in accordance with various embodiments of these teachings;

FIG. 6 comprises a screen shot as configured in accordance with various embodiments of these teachings; and

FIG. 7 comprises a top pan view as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, these various embodiments will support and facilitate providing one kind of categorical type of information regarding an item to an entity (such as a particular person) presumptively seeking a different kind of categorical type of information regarding that item. By one approach these embodiments are carried out while the item is at a location that offers a service that corresponds to the aforementioned different kind of categorical type of information.

By one approach these teachings provide a portable handheld device having an optical scanner and a wireless communications capability. That portable handheld device serves to scan an optical identification code on the aforementioned item and to transmit identification information corresponding to that optical identification code to a particular remote resource. Upon receiving the aforementioned one kind of categorical type of information from the remote resource at the portable handheld device, at least some of that information can be printed as hard copy and provided to the aforementioned entity.

By way of example and without intending any particular limitations in these cards, the aforementioned different kind of categorical type of information can comprise information regarding servicing the item while the other kind of categorical type of information can comprise valuation information regarding a value of the item.

When the aforementioned item comprises a terrestrial vehicle such as a used automobile, the aforementioned optical identification code can comprise the well-known vehicle identification number (VIN). In such a case, and by one approach, the portable handheld device can also serve to receive mileage information for the terrestrial vehicle and to provide that mileage information to the aforementioned remotes resource when also transmitting the aforementioned identification information that corresponds to the optical identification code.

By one approach, the aforementioned hard copy can include metadata regarding the item. As an example, when the item comprises a used automobile, the metadata can include manufacturer information, model information, and/or a model year for the item.

So configured, a person can be conveniently provided with reliable information that is relevant to an item of interest to that person notwithstanding that the person was not (at least openly) seeking such information nor even necessarily aware that such information could be readily accessed. Once supplied with the information, however, and presuming an appropriate application setting, this person has the opportunity to leverage their newfound knowledge to their benefit. Those skilled in the art will also appreciate that a person needs essentially no training or background knowledge or experience to receive the benefits of these teachings. In particular, this person needs no information that identifies the aforementioned remote resource and does not even need to own or control any network capable devices that can serve to interact with such a resource.

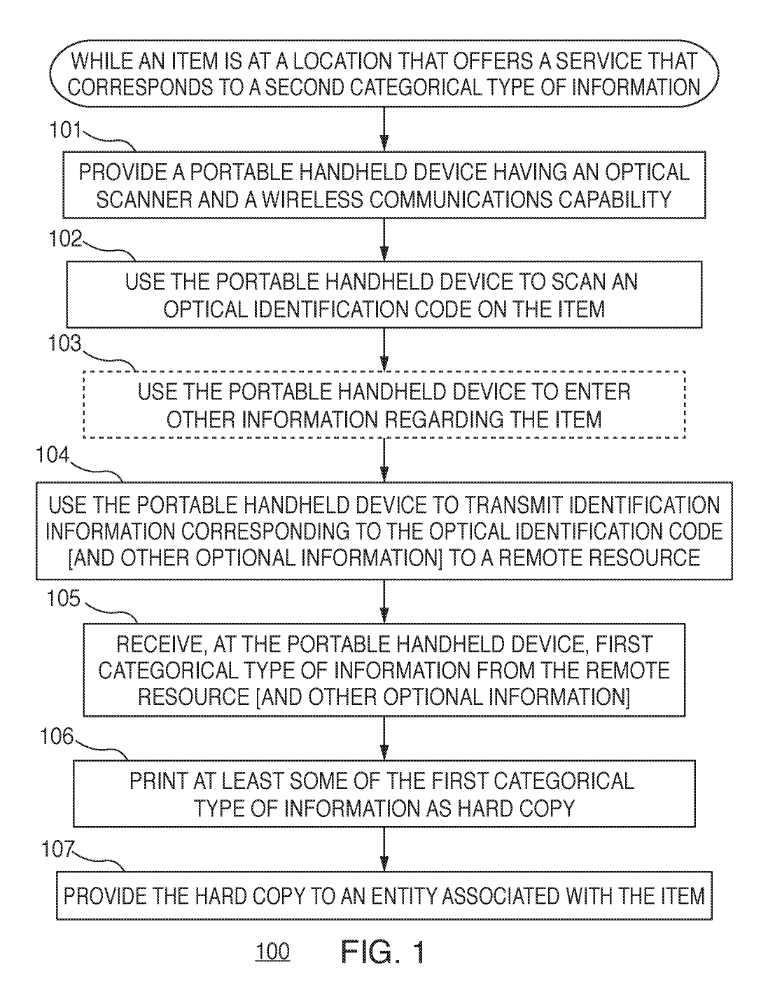

These and other benefits may become clearer upon making a thorough review and study of the following detailed description. Referring now to the drawings, and in particular to FIG. 1, an illustrative process 100 that provides a first categorical type of information regarding an item and that is compatible with many of these teachings will now be presented.

This process 100 presumes a certain set of circumstances. In particular, this process 100 takes place while the item is at a location that offers a service that corresponds to a second categorical type of information regarding the item. More particularly, this process 100 takes place while an entity (such as a person) presumptively seeks the second categorical type of information regards the item.

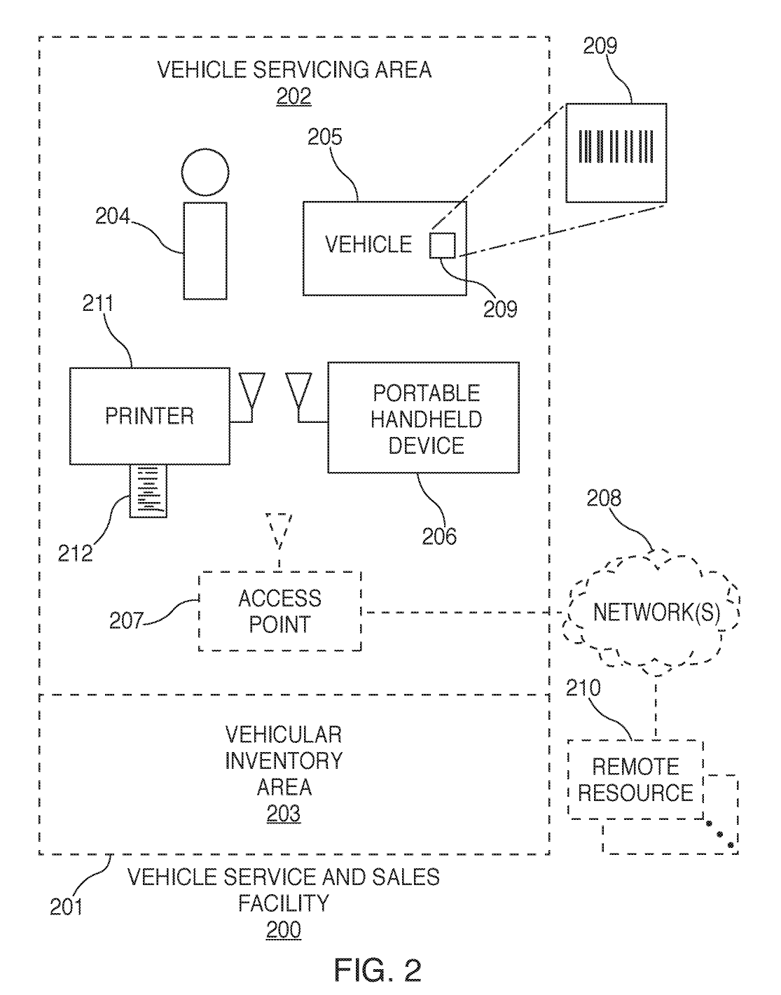

For the sake of an illustrative example and without intending any particular limitations by way of these details, FIG. 2 presents an application setting 200 that includes a vehicle service and sales facility 201 having both a vehicle servicing area 202 and a vehicular inventory area 203. Although these two areas 202 and 203 are shown as being physically discrete from one another in this illustrative example, it will be understood that these two areas 202 and 203 may partially physically overlap with one another in a given application setting.

The vehicular inventory area 203 may be an indoor and/or an outdoor area having one or more new or used vehicles that are offered for sale to the general public. The vehicle servicing area 202 will typically include an intake area where persons 204 can bring their vehicles 205 to be serviced and one or more service bays or other areas where such vehicles can receive inspection, maintenance, and/or repair services.

So configured, and again as an illustrative example, the aforementioned second categorical type of information can comprise information regarding servicing a vehicle that constitutes the aforementioned item. Accordingly, the second categorical type of information can comprise, for example, information regarding recommended services and/or repairs (including a time frame to complete such services/repairs and/or an estimated or firm cost associated with such services/repairs). By one approach the vehicle service and sales facility 201 also includes a visitor area where persons having their vehicles maintained/serviced can safely and comfortably wait for their vehicles to become available to them again.

Accordingly, and to be clear, in this example the process 100 presented in FIG. 1 occurs while a vehicle 205 is at the vehicle servicing area 202 and while the person 204 that corresponds to that vehicle 205 is presumptively seeking a categorical type of information pertaining to servicing the vehicle 205.

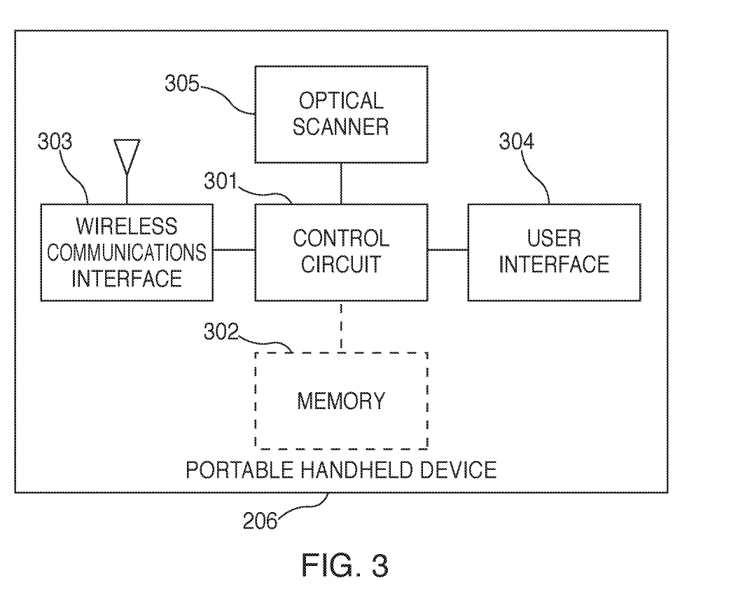

With continued reference to FIGS. 1 and 2, at block 101 this process 200 provides a portable handheld device 206. FIG. 3 presents an illustrative example of this portable handheld device 206. In this example, the portable handheld device 206 includes a control circuit 301. Being a “circuit,” the control circuit 301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 301 is configured (for example, by using corresponding programming as will be well understood by those skilled in the art) to carry out one or more of the steps, actions, and/or functions described herein.

By one optional approach the control circuit 301 operably couples to a memory 302. This memory 302 may be integral to the control circuit 301 or can be physically discrete (in whole or in part) from the control circuit 301 as desired. This memory 302 can also be local with respect to the control circuit 301 (where, for example, both share a common circuit board, chassis, power supply, and/or housing) or can be partially or wholly remote with respect to the control circuit 301 (where, for example, the memory 302 is physically located in another facility, metropolitan area, or even country as compared to the control circuit 301).

This memory 302 can serve, for example, to non-transitorily store the computer instructions that, when executed by the control circuit 301, cause the control circuit 301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 301 also operably couples to a wireless communications interface 303. So configured the control circuit 301 can communicate with other elements via the wireless communications interface 303. In this example the wireless communications interface 303 is presumed to comprise a Wi-Fi capable interface. Wi-Fi refers to a technology that allows electronic devices to connect to a wireless Local Area Network (LAN) (generally using the 2.4 gigahertz and 5 gigahertz radio bands. More particularly, “Wi-Fi” refers to any Wireless Local Area Network (WLAN) product based on interoperability consistent with the Institute of Electrical and Electronics Engineers' (IEEE) 802.11 standards. Such interfaces are well understood in the art and require no particular elaboration here. It should be noted, however, that the aforementioned vehicle service and sales facility 201 can include an access point 207 that compatibly communicates with the aforementioned wireless communications interface 303 to thereby provide access to one or more networks 208 including, but not limited to, the Internet.

In this example the control circuit 301 further operably couples to a user interface 304. This user interface 304 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

And, also in this example, the control circuit 301 operably couples to an optical scanner 305. This optical scanner 305 may include, for example, one or more digital cameras though any number of other optical scanning modalities can be accommodated as desired.

By one approach the portable handheld device 206 comprises a custom-built platform. That said, the applicant has determined that some existing platforms can serve the purposes of these teachings provided those platforms are appropriately configured to carry out the described process 100. For example, the applicant has determined that an iPod iTouch can be configured for the present purposes. The iPod Touch is an iOS-based all-purpose mobile device designed and marketed by Apple Inc. and includes a touchscreen-controlled user interface. It connects to the Internet only through Wi-Fi base stations and does not use cellular network data.

With continued reference to FIGS. 1 and 2, at block 102 this process 100 provides for using the portable handheld device 206 to scan an optical identification code 209 on the item (in this case, the vehicle 205). Generally speaking, optical codes are comprised of nonalphabetic graphic elements (such as lines having various thicknesses and spacings relative one another) that represent alphanumeric content. While the present teachings are not overly sensitive to any particular selections in these regards, for the sake of an example it will be presumed here that the optical identification code 209 comprises a barcode.

And, again for the sake of an example, it will be further presumed that in this particular example the optical identification code comprises a so-called vehicle identification number (VIN). Those skilled in the relevant art will know that a VIN is a unique code, including a serial number, used by the automotive industry to identify individual vehicles. Modern vehicle identification numbers are based on two related standards originally issued by the International Organization for Standardization (ISO) (namely, ISO 3779 and ISO 3780). By one approach, for example, such an optical identification code can be found in the driver side door frame of the vehicle.

These teachings will of course accommodate other approaches in these regards. For example, part or all of the vehicular license plate could be optically scanned to obtain the license plate number for the corresponding vehicle. That license plate number could then serve as the basis of queries to glean, for example, the VIN or other information regarding the vehicle.

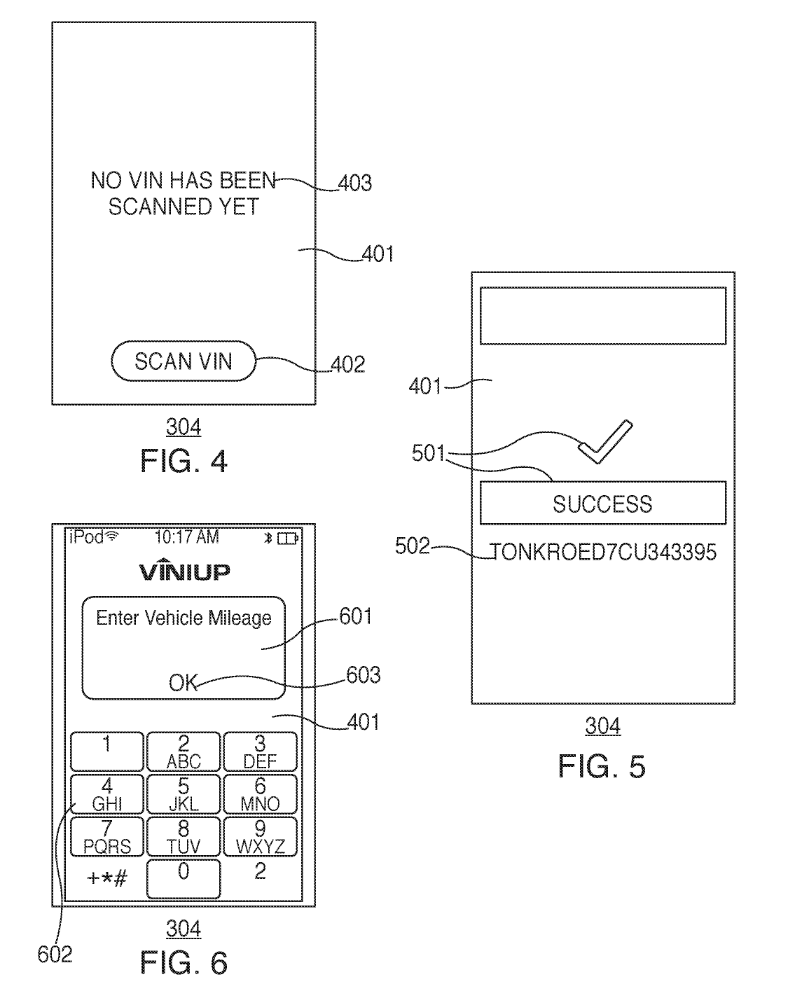

FIGS. 4 and 5 present a further illustrative example in these regards. In these views the aforementioned user interface 304 of the portable handheld device 206 comprises a touch-screen display 401. In FIG. 4, the user scans the optical identification code 209 by tapping a corresponding “scan” button 402. In this example, the display 401 also presents a message 403 to advise the user that scanning has not yet occurred. This message 403 can comprise text (as shown), non-textual graphic or icon-based content, or both as desired.

FIG. 5 presents a post-scan presentation on the display 401. In this example this presentation includes informational content 501 to indicate a successful scan. In this example the post-scan presentation also includes informational content comprising (or otherwise referencing) part or all of the optical identification code 209 (in this specific example, the VIN for the vehicle 205). Using this approach the user can, if they wish, compare the displayed optical identification code information against the actual VIN on the vehicle 205 to confirm an accurate scan.

At optional block 103 of FIG. 1, if desired, these teachings will accommodate using the portable handheld device 206 to also enter other information regarding the item in addition to the aforementioned optical identification code 209. As one specific, non-limiting example in these regards, the user can enter mileage information for a terrestrial vehicle 205 via the portable handheld device 206. FIG. 6 provides an illustrative example in these regards where the display 401 presents a field 601 in which the user can enter the vehicle mileage using a displayed touchpad 602. Upon entering the mileage, the user can assert, in this example, an “OK” button 603 to complete entry of the mileage information.

By one approach, these teachings will accommodate a set-up protocol during which the user selects whether mileage information is entered in “miles” or “kilometers.” By another approach, in lieu of the foregoing or in combination therewith, the user can be provided with an opportunity to select the units for the measured parameter at the time of entering that information.

At block 104 this process 100 provides for using the portable handheld device 206 to transmit identification information corresponding to the optical identification code 209 to an appropriate pre-selected (and likely pre-programmed) remote resource (denoted by reference numeral 210 in FIG. 2). If desired, this transmitted information can include other information such as, for example, the above-described vehicle mileage information. The remote resource 210 can comprise, for example, the so-called Blue Book vehicle valuation service or the so-called Black Book vehicle valuation service which are known in the art. By one approach, the user has preselected a particular valuation service to use for all valuations in which case the portable handheld device 206 would automatically forward the indicated information to that preselected service.

At block 105, the portable handheld device 206 receives a first categorical type of information from the remote resource 210 (including other information as desired). To continue with the present specific example, this first categorical type of information comprises valuation information regarding a value of the aforementioned item (in this case, a trade-in value for the vehicle 205). If desired, the portable handheld device 206 can receive other information as well regarding the item. Examples include but are not limited to non-valuation metadata for the item. When the item comprises a terrestrial vehicle, examples in these regards include a model year for the vehicle, make information for the vehicle (i.e., the manufacturer for the vehicle), and model information for the vehicle (such as the model name, a trim level identifier, and so forth).

With continued reference to FIGS. 1 and 2, at block 106 this process 100 provides for using a local printer 211 to print at least some of the first categorical type of information as hard copy 212. By one approach, the printer 211 can comprise a user-worn/carryable wireless portable printer (as manufactured, for example, by Star Micronics).

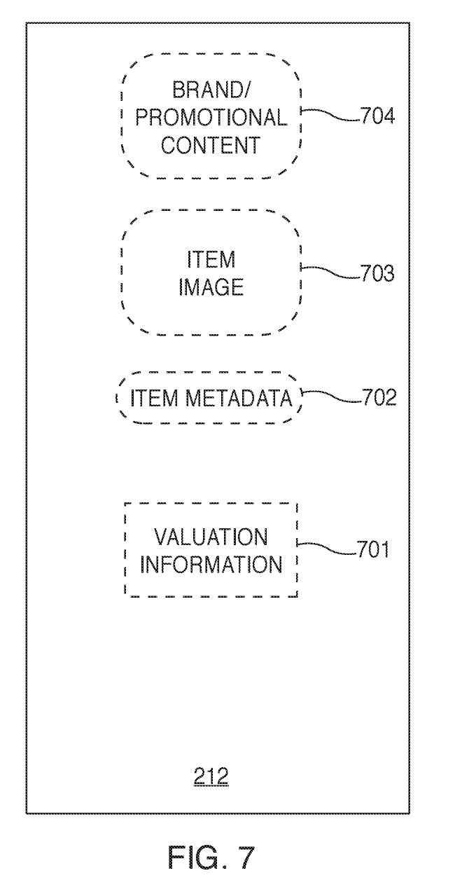

FIG. 7 provides an illustrative example in these regards (presuming that the item comprises a vehicle 205). In this example the hardcopy 212 comprises a paper printout that presents valuation information 701 (representing, in this example, a trade-in value for the vehicle 205). For example, this valuation information 701 might read, in a given instance, “$15,535.00.”

If desired, this printout hardcopy 212 may also present one or more metadata items 702. Examples in these regards can include, as suggested above, model year information, make information, and/or model information for the vehicle 205.

If desired, these teachings will also accommodate providing an image 703 of the item on the hardcopy printout 212. This image 703 can present a generic stock representation corresponding to the item or, if desired, can constitute an image of the actual item itself.

These teachings will further accommodate a wide variety of other informational content. As one simple illustrative example in these regards, a brand and/or other promotional content 704 that pertain to the corresponding vehicle service and sales facility 201 can be included on the hardcopy 212. Other potentially useful information items include contact information for the facility 200 and/or particular employees for associates of the facility 200.

At block 107 this process 100 specifies providing the aforementioned hard copy 212 to an entity associated with the item. In the foregoing example, this can comprise delivering the hardcopy 212 to the person 204 who brought the vehicle 205 to the vehicle servicing area 202 for attention.

So configured, a person who arrived with an item at a location presumptively seeking one categorical type of information regarding that item also additionally receives a different categorical type of information regarding that item. While this different categorical type of information may not have originally been sought by this person, this supplemental information (i.e., supplemental to the categorical type of information that they were originally presumptively seeking) can nevertheless be highly relevant in context. For example, when the item comprises a vehicle, the location comprises both a vehicle service and sales facility, and the supplemental information comprises valuation information for the vehicle, knowledge regarding the latter may be useful to this person who then seeks to leverage that information when considering the purchase of another vehicle from this facility. In that context, there are not any high pressure (or even any) sales tactics to be endured by this person. Nevertheless, this visitor can receive valuable information that is relevant to both their vehicle and the location where the information is gleaned.

It will be appreciated that these teachings differ considerably from prior art techniques in these regards. In particular, pursuant to past practices, the person would either specifically seek out such valuation information of their own accord or they would visit such a facility with the specific intent of exploring the purchase of an automobile and with an expectation of receiving a trade-in quote from the facility in those regards. It will also be appreciated that the person with the item need not themselves have any training or even any particular devices in order to receive the foregoing benefits.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

As one example in these regards, some optical identification codes (such as VIN's) are geographically limited. As an example in these regards, an “American” car visiting a vehicle dealership in Canada does not have a VIN that corresponds to a “Canadian” car and hence cannot be used to access typical resources that provide valuation information for Canadian vehicles. With that in mind, the portable handheld device 206 can be configured to provide an appropriate notice to the user when scanning a VIN that is not geographically appropriate. For example, such a notice could specifically explain that the scanned alphanumeric string is not a geographically-appropriate VIN.

As another example in these regards, these teachings will accommodate taking one or more digital images of the item and sending those images to the remote resource 210 along with the optical identification code information. The remote resource 210 could then be configured (for example, by leveraging an artificial intelligence component or resource) to examine that image for those images to further inform the, for example, valuation information provided in reply. For example, obvious accident damage could be taken into account when providing a trade-in valuation figure per the foregoing teachings.

As yet another example, the foregoing process can generate data that can be provided as a report to an interested party, such as the manager of the above-described vehicle service and sales facility 200. That information could include such things as identifying information for the vehicle, the date the vehicle visited the facility for servicing, contact information for the vehicle's owner, the valuation information provided per the foregoing, and any of a wide variety of customer relationship management (CRM) information to help facilitate further promotional offerings, statistical analysis, sales leads, and so forth.

And as yet another example, by one approach the portable handheld device 206 could be configured with an interface to compatibly couple to a vehicle's diagnostic interface. So configured the portable handheld device 206 could receive any of a variety of diagnostic codes or other recorded metrics for the aforementioned vehicle 205. The portable handheld device 206 could then include at least some of that content when communicating with the remote resource 210 to permit the latter to utilize that information to develop a more informed and nuanced valuation figure.

What is claimed is:

1. A method to provide a first categorical type of information regarding an item to an entity presumptively seeking a second categorical type of information regarding the item, comprising, while the item is at a location that offers a service that corresponds to the second categorical type of information:
providing a portable handheld device having an optical scanner and a wireless communications capability;
using the portable handheld device to scan an optical identification code on the item;
using the portable handheld device to transmit identification information corresponding to the optical identification code to a remote resource;
receiving, at the portable handheld device, the first categorical type of information from the remote resource;
printing at least some of the first categorical type of information as hard copy;
providing the hard copy to the entity.

2. The method of claim 1 wherein the second categorical type of information comprises information regarding servicing the item.

3. The method of claim 2 wherein the first categorical type of information comprises valuation information regarding a value of the item.

4. The method of claim 1 wherein the item comprises a terrestrial vehicle.

5. The method of claim 4 wherein the optical identification code comprises a vehicle identification number (VIN).

6. The method of claim 4 further comprising:
using the portable handheld device to enter mileage information for the terrestrial vehicle;
and wherein using the portable handheld device to transmit the identification information corresponding to the optical identification code to the remote resource further comprises transmitting the mileage information to the remote resource.

7. The method of claim 1 wherein printing at least some of the first categorical type of information as hard copy comprises using a portable printer to print the hard copy.

8. The method of claim 1 wherein printing at least some of the first categorical type of information as hard copy further comprises also printing on the hard copy metadata regarding the item.

9. The method of claim 8 wherein the metadata includes a model year for the item.

10. An apparatus comprising:
a vehicle service and sales facility having both a vehicle servicing area and a vehicular inventory area;
a printer;
a portable handheld device having an optical scanner, a wireless communications interface, a user interface, and a control circuit operably coupled to the optical scanner, the wireless communications interface, and the user interface and configured to:
respond to a scan instruction entered via the user interface by scanning an optical identification code on a service customer's vehicle that has been brought to the vehicle servicing area;
transmit identification information corresponding to the optical identification code to a remote resource via the wireless communications interface;
receive, via the wireless communications interface, valuation information for the vehicle from the remote resource;
communicate with the printer to cause the printer to print at least some of the valuation information as hard copy.

11. The apparatus of claim 10 wherein the optical identification code comprises a vehicle identification number (VIN).

12. The apparatus of claim 11 wherein the optical identification code comprises a barcode.

13. The apparatus of claim 11 wherein the portable handheld device is configured to scan the optical identification code by scanning an optical identification code disposed within a doorframe of the vehicle.

14. The apparatus of claim 10 wherein the control circuit is further configured to:
receive mileage information for the terrestrial vehicle via the user interface;
and wherein transmitting the identification information corresponding to the optical identification code to the remote resource also includes transmitting the mileage information to the remote resource.

15. The apparatus of claim 10 wherein the printer comprises a portable printer.

16. The apparatus of claim 10 wherein the control circuit is further configured to receive, via the wireless communications interface, non-valuation metadata for the vehicle from the remote resource;
and wherein communicating with the printer to cause the printer to print at least some of the valuation information as hard copy further comprises communicating with the printer to also cause the printer to print at least some of the non-valuation metadata on the hard copy.

17. The apparatus of claim 16 wherein the metadata includes a model year for the vehicle.

18. The apparatus of claim 17 wherein the metadata further includes make and model information for the vehicle.
